(19) United States
(12) Patent Application Publication
(10) Pub. No.: US 2008/0216613 A1
(43) Pub. Date: Sep. 11, 2008

(54) PROTECTION COVER FOR COVERING TORQUE MEASURING DEVICE

(76) Inventor: CHIH-CHING HSIEH, Taichung Hsien (TW)

Correspondence Address: BENJAMIN SU, P.O.BOX 70-121 Taichung, Taichung City, 40899, TW

(21) Appl. No.: 12/125,928

(22) Filed: May 23, 2008

Related U.S. Application Data
(62) Division of application No. 11/480,952, filed on Jul. 6, 2006.

(51) Int. Cl. B25B 13/00

(52) U.S. Cl. 81/176.1

(57) ABSTRACT

A hand tool includes a handle and a function head is connected to an end of the handle. A recessed area is defined in a side of the handle and a display screen and operation buttons are received in the recessed area. A cover is engaged with the recessed area so as to removably cover the display screen and/or the operation buttons.

### CROSS-REFERENCE TO RELATED APPLICATION

This application is a Divisional application of Ser. No. 11/480,952, filed 6 Jul. 2006, and entitled “PROTECTION COVER FOR COVERING TORQUE MEASURING DEVICE”, now pending.

### BACKGROUND OF THE INVENTION

1. Field of the Invention

The present invention relates to a protection cover for removably covering the torque measuring device on handle of hand tool.

2. Description of Related Art

A conventional hand tool with a torque measuring device is located on the handle and generally includes a display screen and operation buttons. When the user holds the handle and rotate to tighten or loosened an object, the display screen displays the torque that is applied to the object so as to protect the object from being damaged by overly applied torque. During the operation of the hand tool, the user's fingers might press the operation buttons and/or the display screen, and this may result the electronic parts to be damaged.

The present invention intends to provide a protection cover which is slidably or pivotally connected to the handle of the hand tool and can cover the display screen and/or the operation buttons when needed.

### SUMMARY OF THE INVENTION

The present invention relates to a hand tool which includes a handle and a function head that is connected to an end of the handle. A recessed area is defined in a side of the handle and a display screen and operation buttons are received in the recessed area. Top surfaces of the display screen and the operation buttons are lower than an outer surface of the side of the handle. A cover is engaged with the recessed area so as to removably cover the display screen and/or the operation buttons.

The present invention will become obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the first embodiment of the protection cover and the hand tool of the present invention;

FIG. 2 is a perspective view to show that the cover is engaged with the recessed area in the handle of the hand tool of the present invention;

FIG. 2A shows that the cover is slid to cover the operation buttons;

FIG. 2B shows that the cover is slid to cover the display screen;

FIG. 3 is an exploded view to show the second embodiment of the protection cover and the hand tool of the present invention;

FIG. 4 shows the third embodiment of the protection cover and the hand tool of the present invention;

FIG. 5 shows two types of covers are connected to the handle;

FIG. 6 shows the fourth embodiment of the cover of the present invention; and

FIG. 7 shows that the cover is provided about the pivot.

### DETAILED DESCRIPTION OF THE INVENTION

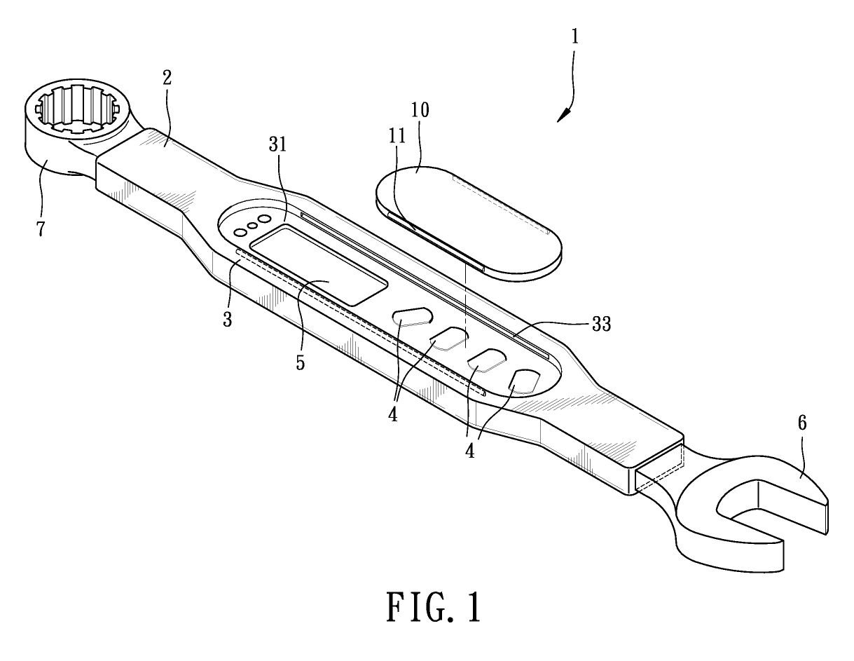

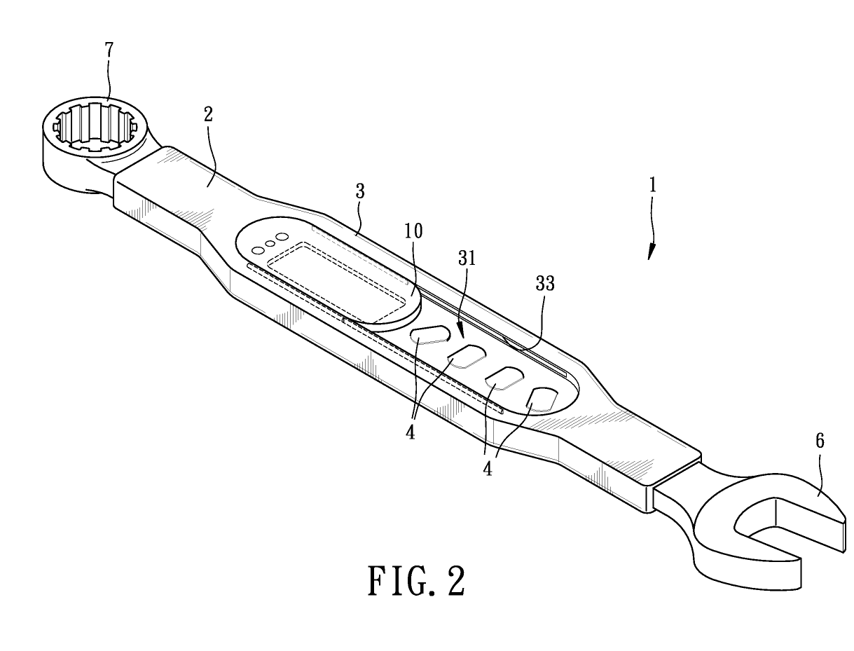

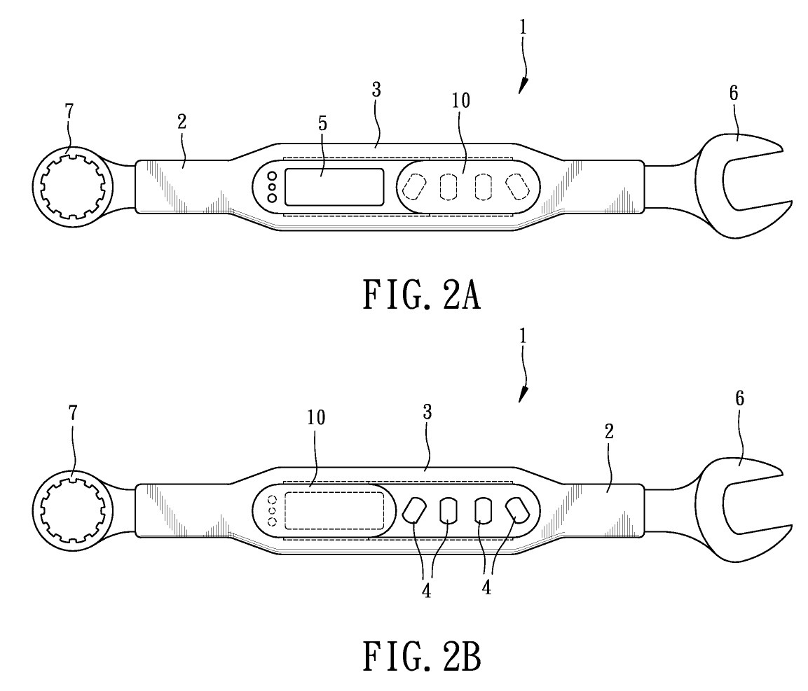

Referring to FIGS. 1 and 2, the hand tool 1 of the present invention comprises a handle 2 and two function heads 6 and 7 are connected to two ends of the handle 2. The handle 2 includes a wide section 3 for convenience of grasp for the user. A recessed area 31 is defined in a side of the handle 3 and a display screen 5 and a plurality of operation buttons 4 are received in the recessed area 31. The operation buttons 4 and the display screen 5 are located along an axis of the handle 2. The respective top surfaces of the display screen 5 and the operation buttons 4 are lower than an outer surface of the side of the handle 3.

A transparent cover 10 has two ridges 11 extending from two sides thereof and two grooves 33 are defined in two respectively inner sides of the recessed area 31. The two ridges 11 are slidably engaged with the two grooves 33. A length of the cover 10 is shorter than a length of the recessed area 31 so that the cover 10 can be slid along the grooves 33 to cover the operation buttons 4 as shown in FIG. 2A or to cover the display screen 5 as shown in FIG. 2B. The top surface of the cover 10 is in flush with the outer surface of the handle 2 so that the user can comfortably hold the handle 2 when using the hand tool 1.

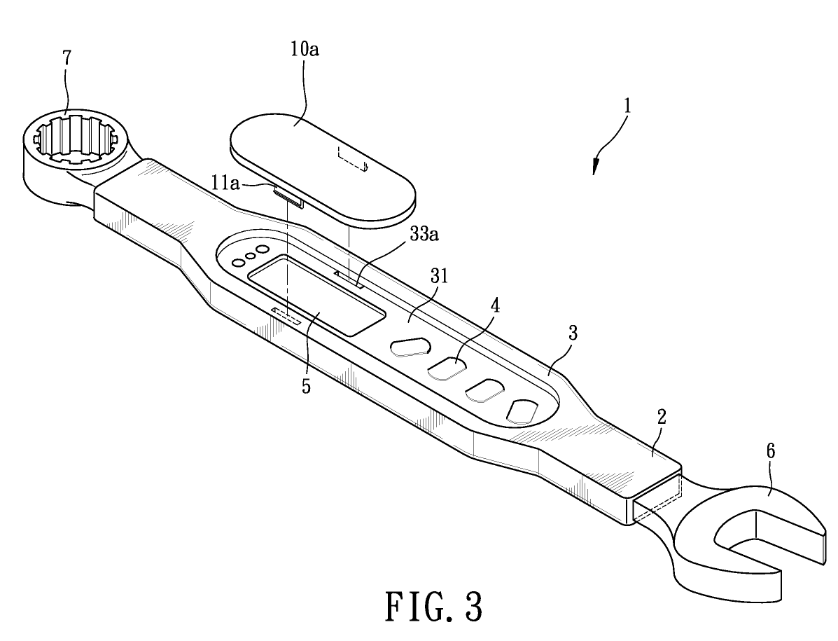

FIG. 3 shows that the cover 10a may have two insertions 11a extending from two sides thereof and two notches 33a are defined in an interior end of the recessed area 31. The two insertions 11a are removably engaged with the notches 33a so as to cover the display screen 5.

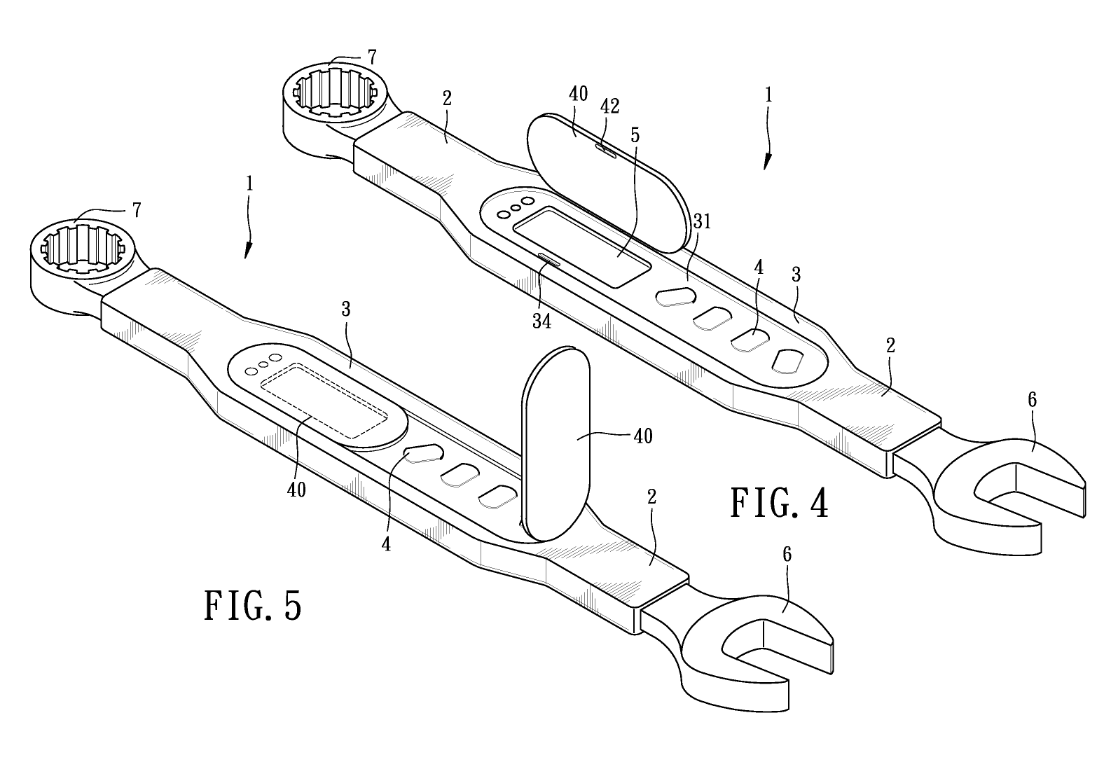

FIG. 4 shows that the cover 40 may have one side pivotally connected with an inner periphery of the recessed area 31 and a protrusion 42 extends from an underside of the other side of the cover 40. The recessed area 31 has a recess 34 defined in an interior end thereof, the protrusion 42 is removably engaged with the recess 34.

FIG. 5 shows that the handle 2 can be equipped with two covers 40, one of the covers 40 is designed to cover the display screen 5 as shown in FIG. 4, and the other cover has one end pivotally connected to an inner end of the recessed area 31 so as to cover the operation buttons 4. It is noted that the length of the covers 10a and 40 as shown in FIGS. 3 and 4 can be the same as the recess area 31 so as to cover the display screen 5 and the operation buttons 4 simultaneously.

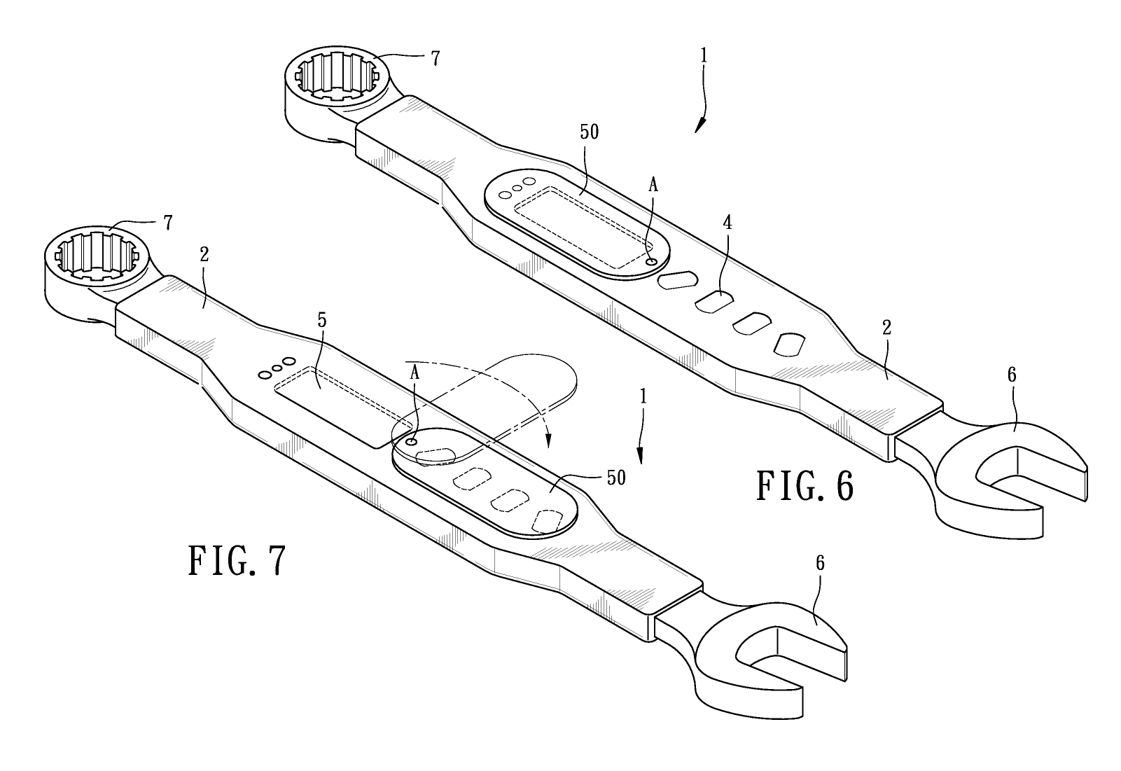

As shown in FIGS. 6 and 7, the display screen 5 and the operation buttons 4 are located on the handle and in flush with the surface of the handle 2. The cover 50 may have one end pivotally connected to the handle 2 by a pivot “A” and the cover 40 pivoted about the pivot “A” to cover the display screen 5. The pivot “A” is located between the display screen 5 and the operation buttons 4 so that the cover 50 is pivoted about the pivot “A” to cover the display screen 5 and the operation buttons 4 alternatively.

While we have shown and described the embodiment in accordance with the present invention, it should be clear to those skilled in the art that further embodiments may be made without departing from the scope of the present invention.

What is claimed is:

1. A hand tool comprising:
a handle and a function head connected to an end of the handle, a recessed area defined in a side of the handle and a display screen received in the recessed area, a top surface of the display screen being lower than an outer surface of the side of the handle; and
a cover engaged with the recessed area and removably covering the display screen.

2. The hand tool as claimed in claim 1, wherein the cover has one end pivotally connected to an inner end of the recesses area.

3. The hand tool as claimed in claim 1, wherein a plurality of operation buttons and the display screen are located along an axis of the handle.

4. The hand tool as claimed in claim 1, wherein the cover is a transparent cover.

5. The hand tool as claimed in claim 2, wherein a plurality of operation buttons and the display screen are located along an axis of the handle.

6. The hand tool as claimed in claim 2, wherein the cover is a transparent cover.

7. The hand tool as claimed in claim 3, wherein the cover is a transparent cover.

8. The hand tool as claimed in claim 5, wherein the cover is a transparent cover.
